(19) United States
(12) Patent Application Publication
(10) Pub. No.: US 2016/0290035 A1
(43) Pub. Date: Oct. 6, 2016

(54) Manhole Flash Shield

(71) Applicant: Commonwealth Edison Company, Oakbrook Terrace, IL (US)

(72) Inventors: Michael W. Boss, Tinley Park, IL (US); Patrick J. Rogers, Chicago, IL (US); Glenn Yeager, Palos, IL (US)

(21) Appl. No.: 14/675,954

(22) Filed: Apr. 1, 2015

(51) Int. Cl. E06B 5/00; E06B 7/23

(52) U.S. Cl. CPC E06B 5/00; E06B 7/2303

(57) ABSTRACT

A cover comprises a frame having first and second sides oppositely disposed from one another. The frame defines a perimeter. A first plate is attached to the first side of the frame. A portion of the first plate extends outwardly from the perimeter and forms an engagement surface surrounding the frame. A second plate is attached to the second side of the frame. The cover has at least one lifting lug attached to the second plate. A gasket is attached to the engagement surface of the first plate. The cover is positioned within an opening to a vault. A portion of the interior surface of the vault forms a peripheral surface surrounding the opening. The cover is drawn against the opening so as to engage the gasket attached to the engagement surface of the cover with the peripheral surface surrounding the opening.

### FIELD OF THE INVENTION

This invention relates to covers for protecting against arc flash hazards in a manhole.

### BACKGROUND

An arc flash is an explosive electrical event highly hazardous to persons in its vicinity. An arc flash may result from failure of power cables. When a power cable fails, electric current flowing through the cable may leave its intended path and flow through the air, causing energy to be released. The energy released is an arc flash. At high voltages, large amounts of energy are released, potentially producing an arc flash with powerful explosions, extremely high temperatures, flames, fumes, blinding light, loud noise, and pressure waves. Persons exposed to such an arc flash could suffer serious injury. It is necessary, therefore, for personnel working within the vicinity of high voltage power cables to be adequately protected from arc flashes that may result from failure of those cables.

Manholes provide access to subterranean high voltage power cables by connecting underground vaults housing power cables to a street level. A vault opening provides access into vault from the manhole. Persons working in the manhole (for example, personnel making repairs to the manhole frame or cover) may be exposed to arc flash events from power cables in the vault through the vault opening. The risk of arc flash events is especially high when the power cables are in poor or deteriorating condition. Thus, personnel require protection from arc flash events when working in a manhole.

Several methods are available for protecting personnel in manholes from arc flash hazard. The methods include de-energizing power cables in the vault, modifying the design or configuration of power cables to minimize arc flash occurrences, inspecting and fixing any cables in poor condition, or covering the vault opening leading to the manhole. However, these methods may be cumbersome, costly, or difficult to implement. De-energizing power cables results in changes in electrical configurations making operations more difficult to manage. Modifying the design or configuration of power cables in the vault is typically not feasible. Although cables in poor or deteriorating condition may be fixed, repair of the cables must be arranged before work in the manhole begins, causing possible delays in repairs to the manhole. Also, the condition of the cables must be inspected first before any repairs to the cables are made, adding to the delay.

Covering the vault opening may therefore provide the most practical option for protecting personnel working in manholes from arc flash hazard. However, the cover must operate as an effective shield against arc flash events in the vault, yet also be easily removable to allow access to the vault when manhole repairs are complete.

It is therefore a challenge to protect personnel working manholes from arc flash hazards and for manhole repairs to be completed safely and efficiently regardless of the manhole or cable condition. It is clear that advantages may be obtained by using a cover which is easily placed and removed and which effectively shields personnel from any arc flash events in the vault.

### SUMMARY OF THE INVENTION

The invention concerns a cover. In an example embodiment, the cover comprises a frame having first and second sides oppositely disposed from one another. The frame defines a perimeter. The example cover may comprise first and second lifting lugs attached to the frame.

A first plate is attached to the first side of the frame. A portion of the first plate extends outwardly from the perimeter and forms an engagement surface surrounding the frame. The first plate may comprise a glass in a polymer base.

The example cover may further comprise a second plate attached to the second side of the frame. The second plate may be substantially parallel to the first plate. The example cover may further comprise at least one lifting lug attached to the second plate. The second plate may comprise a glass in a polymer base. The frame may further comprise one or more connecting members positioned between the first and second plates, forming a central space between the plates.

The example cover may further comprise a gasket attached to the engagement surface of the first plate. The gasket substantially surrounds the frame. The gasket may comprise a flexible resilient tube. The gasket may further comprise a sleeve surrounding the tube.

The invention further comprises a method of shielding a subject from an arc flash. An example method comprises positioning a cover within an opening to a vault having an interior space. Positioning the cover within the opening may further comprise lowering of the cover to the opening, tilting the cover, and inserting the cover into the opening.

A portion of the interior surface of the vault forms a peripheral surface surrounding the opening. The cover comprises a first plate attached to a frame defining a perimeter. A portion of the first plate extends outwardly from the perimeter and forms an engagement surface surrounding the frame. The example method also comprises drawing the cover so as to bring the engagement surface proximate to and in facing relation to the peripheral surface surrounding the opening. The example method may further comprise engaging a gasket attached to the engagement surface of the cover with the peripheral surface surrounding the cover so as to form a seal. The example method may further comprise securing the engaged cover in place so as to maintain the seal.

### BRIEF DESCRIPTION OF THE DRAWINGS

FIG. 1 is an isometric view of an example cover according to the invention;

FIGS. 2 and 3 are isometric views of an example method of using a cover according to the invention; and

FIGS. 4 and 5 are cross-sectional views of the example cover shown in FIG. 1.

### DETAILED DESCRIPTION

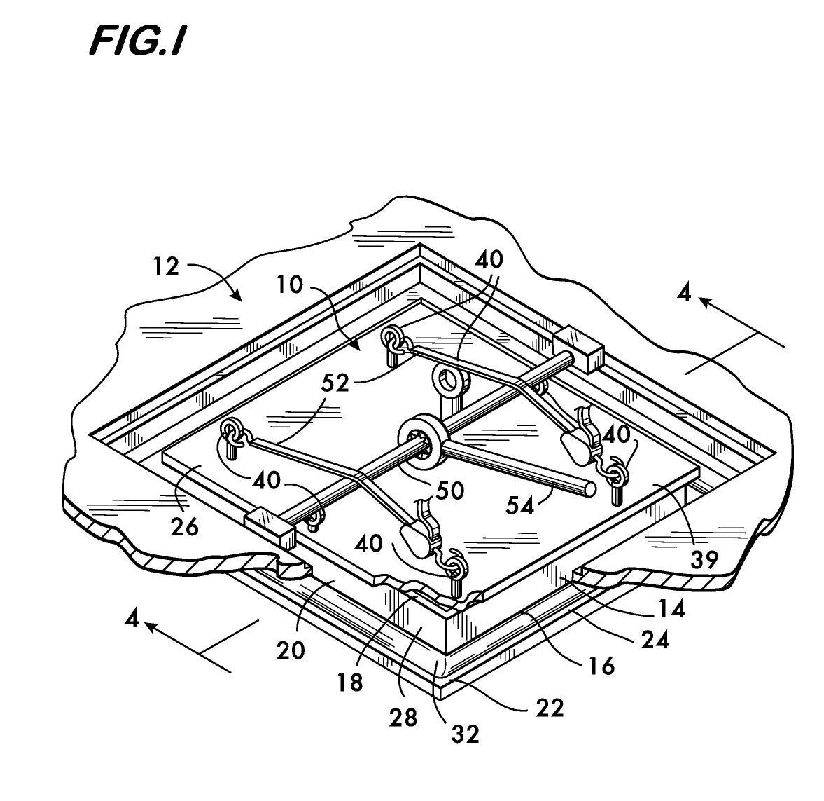

FIG. 1 shows an example cover 10 according to the invention. The cover 10 is installed to an opening 12, where it shields a manhole 13 above the opening 12 from any arc flash events occurring below the opening 12.

The cover 10 comprises a frame 14 having a first side 16 and a second side 18 oppositely disposed from one another. The frame 14 defines a perimeter 20. A first plate 22 is attached to the first side 16 of the frame 14. A portion of the first plate 22 extends outwardly from the perimeter 20 and forms an engagement surface 24 surrounding the frame 14. The cover 10 further comprises a second plate 26. The second plate 26 is attached to the second side 18 of the frame 14 and is substantially parallel to and spaced apart in relation to the first plate 22. The frame 14 further comprises one or more connecting members 28 positioned between the first 22 and second plates 26 and forming a central space 30 between the plates 22 and 26. Advantageously, the frame 14 is formed from aluminum.

The cover 10 may further comprise lifting lugs 40 to allow convenient positioning, maneuvering, and securing of the cover 10. The lifting lugs 40 may be attached to the frame 14 or the second plate 26. As shown in FIG. 1, for example, the cover 10 may comprise a lifting lug 40 attached to the frame 14 and protruding from the second plate 26. The lifting lug 40 is positioned at the center of the cover 10 to allow convenient lowering or lifting of the cover 10 into the opening 12. FIG. 1 also shows a plurality of additional lifting lugs 40 attached to the frame 14 and positioned along the periphery 39 of the cover 10. The lifting lugs 40 may be positioned on the cover 10 in any configuration desirable for facilitating transport and maneuvering of the cover 10.

For the cover 10 to effectively shield against an arc flash, the plates 22 and 26 attached to the frame 14 are formed from materials providing sufficient electrical insulation and flame and heat resistance. Such materials may include plastics, including thermosetting phenol formaldehyde resins such as polyoxybenzyl methylene glycol anhydride (Bakelite™). The materials may also include composite materials comprising glass and plastic, such as glass fibers in a polymer resin base. The glass fibers may be woven into a mat or in random configuration. The plates 22 and 26 may also be formed of laminate material. Advantageously, the plates 22 and 26 are laminate sheets of GPO-3, a random, non-woven mat of glass fibers held together by a polyester resin binder.

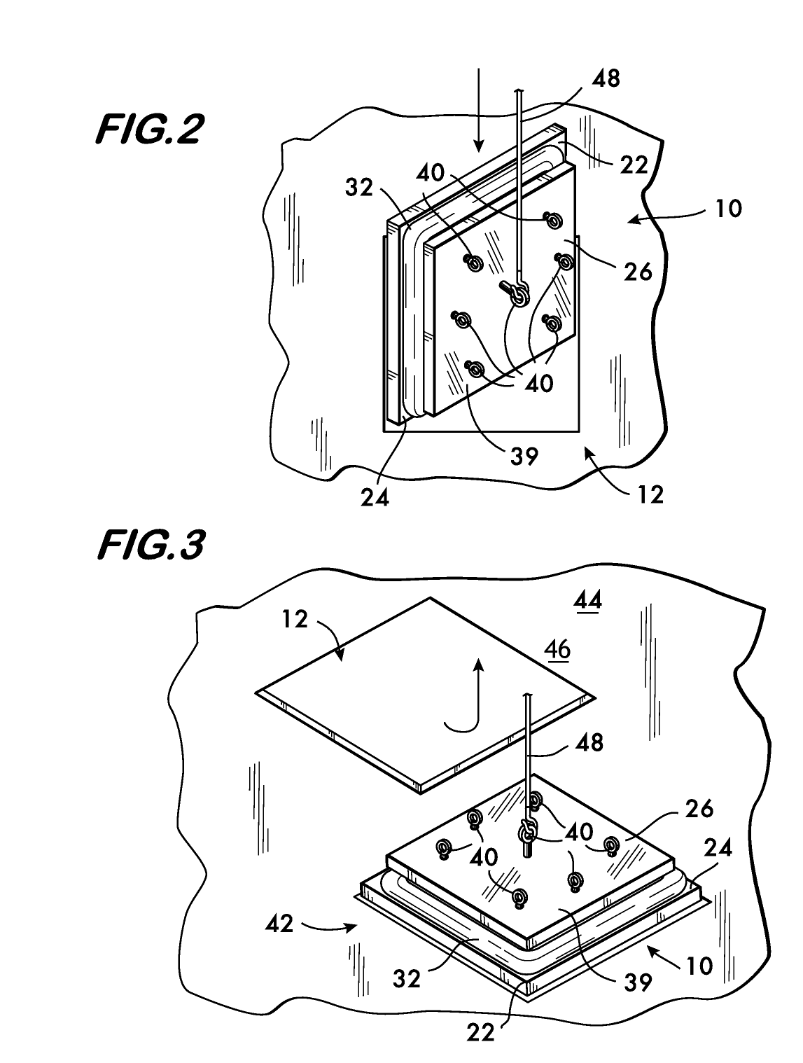

To protect against arc flash, the cover 10 is temporarily installed to an opening 12 leading to a vault 42 housing power cables. When installed, the cover 10 protects the manhole 13 located above the vault 42 against exposure from arc flash events that may occur in the vault 42 from failing power cables. As shown starting with FIG. 2, to install the cover 10 to an opening 12, the cover 10 is first positioned within the opening 12. Then, the cover 10 is drawn to engage the gasket 32 attached to the engagement surface 24 of the cover 10 with a portion of the interior surface 44 of the vault 42 forming a peripheral surface 46 surrounding the opening 12. The gasket 32 engages with the peripheral surface 14 to form a seal 34. Finally, the engaged cover 10 is secured in place to maintain the seal 34.

The cover 10 may be positioned within the opening 12 by lowering the cover 10 to the opening 12 then tilting the cover 10 to insert the cover 10 into the opening 12 (FIG. 2). The cover 10 may be lowered to the opening 12 using a safety line 48 drawn by a winch, where the safety line 48 is attached to at least one lifting lug 40 on the cover 10. In FIG. 2, the safety line 48 is attached to the lifting lug 40 at the center of the cover 10. The cover 10 is then inserted into the opening 12 by tilting the cover 10 to its side to allow the cover 10 to pass through the opening 12 and enter the vault 42. Once inserted into the opening 12, the cover 10 is tilted back in an upright position (FIG. 3). The cover 10 may be tilted or maneuvered as desired by drawing or releasing additional lines attached to the lifting lugs 40 on the cover 10.

To close the opening 12, the cover 10 is drawn to the opening 12, which draws the engagement surface 24 towards the peripheral surface 46 (FIG. 3). For a seal 34 to form between the engagement surface 24 and the peripheral surface 46 when the cover 10 is drawn, advantageously, a gasket 32 is attached to the engagement surface 24. For example, in FIGS. 2 and 3, the cover 10 comprises a gasket 32 attached to the engagement surface 24 of the first plate 22 and substantially surrounding the frame 14.

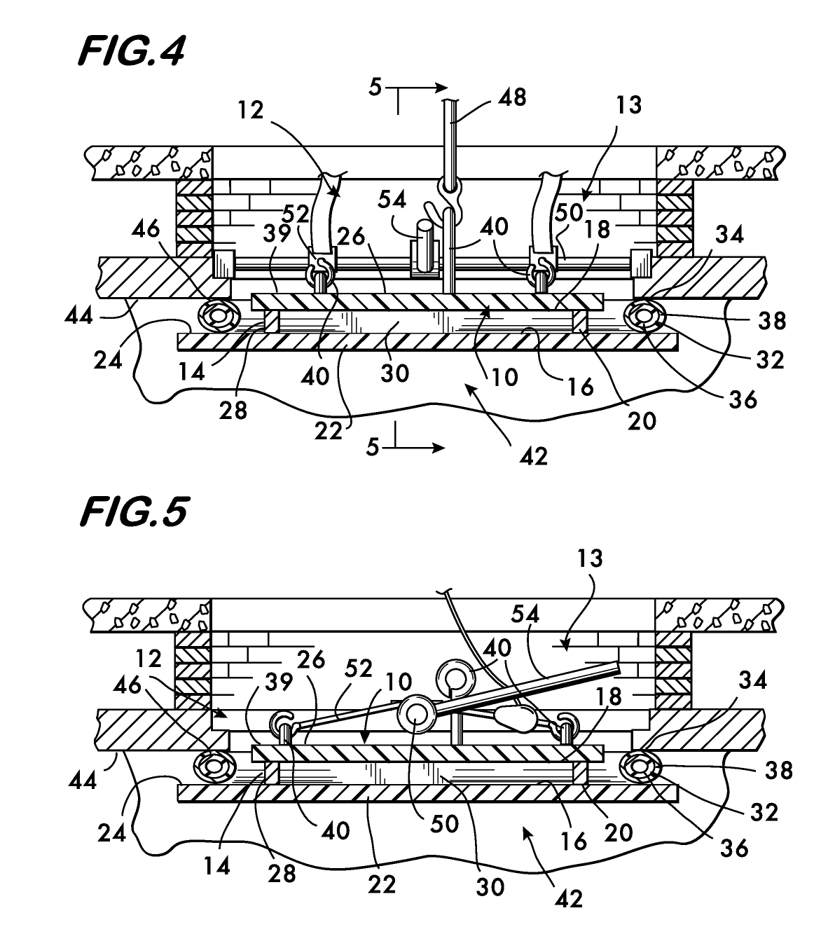

When the cover 10 is drawn to the opening 12, the engagement surface 24 is brought in proximity to and in facing relation to the peripheral surface 46, allowing the gasket 32 to engage with the peripheral surface 46. FIGS. 4 and 5 show the cover 10 drawn to the opening 12 with the gasket 32 engaged to the peripheral surface 46. The gasket 32 may be engaged with the peripheral surface 46 to form a seal by further drawing of the engagement surface 24 toward the peripheral surface 46 to compress the gasket 32 against the peripheral surface 46. As the gasket 32 deforms under compression, the gasket 32 fills in any uneven spaces between the engagement surface 24 and the peripheral surface 46, thereby forming a seal 34 (FIGS. 4 and 5).

For the gasket 32 to effectively form a seal 34, the gasket 32 is formed of flexible resilient materials such as rubber to allow the gasket 32 to deform when compressed. For example, the gasket 32 may comprise a flexible resilient tube 36. Advantageously, the flexible resilient tube 36 is a rubber hose. The flexible resilient tube 36 may be further enclosed in a sleeve 38. Advantageously, the sleeve 38 is formed of leather or a similar tough, abrasive material to make the gasket 32 durable and resistant to damage from repeated use.

Once the cover 10 is engaged and a seal 34 is formed, the cover 10 is then secured in place to maintain the seal 34. The cover 10 may be secured by positioning a fixture (such as a fixed bar 50) above the engaged cover 10 and strapping the cover 10 to the fixture. FIGS. 1, 4, and 5 show an engaged cover 10 secured in place by ratchet straps 52 attached to a fixed bar 50 positioned above the cover 10 and holding the cover 10 in suspension. The ratchet straps 52 are attached to lifting lugs 40 on the cover 10 and attached to a fixed bar 50 positioned above the opening 12 (FIGS. 1, 4 and 5). As shown in FIG. 1, a ratchet device 54 is used to secure fixed bar 50 to opening 12. The ratchet straps 52 allow for further adjustment of the tension and the tightness of the seal 34. The ratchet straps 52 or means of securing the cover 10 may be appropriately selected so as to allow the secured cover 10 to bear the weight of persons or equipment placed in the manhole 13. Once the cover 10 is secured, the manhole 13 is sealed off and protected against any arc flash events from the vault 42, allowing repairs or other work in the manhole 13 to proceed safely. The cover 10 further prevents any debris generated from work in the manhole 13 from falling into the vault 42.

Covers according to the invention and methods of operating the cover are expected to provide effective protection against arc flash events for personnel working in a manhole. They are expected to provide a safe, cost-effective, and efficient way for manhole repairs to be completed without regard to conditions of cables beneath the manhole.

1. A cover, comprising:
a frame having first and second sides oppositely disposed from one another, said frame defining a perimeter;
a first plate attached to said first side of said frame, a portion of said first plate extending outwardly from said perimeter and forming an engagement surface surrounding said frame; and
a second plate integrally attached to said second side of said frame, said second plate oriented parallel to said first plate.

2. The cover according to claim 1, further comprising first and second lifting lugs attached to said frame.

3. (canceled)

4. The cover according to claim 1, further comprising at least one lifting lug attached to said second plate.

5. The cover according to claim 1, further comprising a gasket attached to said engagement surface of said first plate.

6. The cover according to claim 5, wherein said gasket substantially surrounds said frame.

7. The cover according to claim 6, wherein said gasket comprises a flexible resilient tube.

8. The cover according to claim 7, wherein said gasket further comprises a sleeve surrounding said tube.

9. The cover according to claim 1, wherein said first plate comprises a glass in a polymer base.

10. The cover according to claim 1, wherein said second plate comprises a glass in a polymer base.

11. A cover, comprising:
a frame having first and second sides oppositely disposed from one another, said frame defining a perimeter;
a first plate attached to said first side of said frame, a portion of said first plate extending outwardly from said perimeter and forming an engagement surface surrounding said frame;
a second plate integrally attached to said second side of said frame, said second plate oriented parallel to said first plate;
said frame further comprising at least one connecting member positioned between said first and second plates and forming a central space between said plates;
at least one lifting lug attached to said cover; and
a gasket attached to said engagement surface of said first plate.

12. The cover according to claim 11, wherein said first plate comprises a glass in a polymer base.

13. The cover according to claim 11, wherein said second plate comprises a glass in a polymer base.

14. The cover according to claim 11, wherein said gasket substantially surrounds said frame.

15. The cover according to claim 14, wherein said gasket comprises a flexible resilient tube.

16. The cover according to claim 15, wherein said gasket further comprises a sleeve surrounding said tube.

17. A method of shielding a subject from an arc flash, the method comprising:
positioning a cover within an opening to a vault having an interior surface, a portion of said interior surface forming a peripheral surface surrounding said opening, said cover comprising
a first plate attached to a frame defining a perimeter, a portion of said first plate extending outwardly from said perimeter and forming an engagement surface surrounding said frame; and
a second plate integrally attached to said second side of said frame, said second plate oriented parallel to said first plate, and
drawing said cover against said opening so as to bring said engagement surface proximate to and in facing relation to said peripheral surface surrounding said opening.

18. The method according to claim 17, wherein said positioning said cover within said opening further comprises lowering of said cover to said opening, tilting said cover, and inserting said cover into said opening.

19. The method according to claim 17, further comprising engaging a gasket attached to said engagement surface of said cover with said peripheral surface surrounding said opening so as to form a seal.

20. The method according to claim 19, further comprising securing said engaged cover in place so as to maintain said seal.
